(19) United States
(12) Patent Application Publication
(10) Pub. No.: US 2025/0335698 A1
(43) Pub. Date: Oct. 30, 2025

(54) GENERATING TEXT USING MACHINE-LEARNED LARGE LANGUAGE MODELS AND PRESENTING TEXT ON USER INTERFACE

(71) Applicant: Textio, Inc., Seattle, WA (US)

(72) Inventors: Adam Sanderson, Bainbridge Island, WA (US); Cass Petrus, Seattle, WA (US); Jesse Clay Satterfield, Seattle, WA (US)

(21) Appl. No.: 18/647,953

(22) Filed: Apr. 26, 2024

(51) Int. Cl. G06F 40/166; G06F 3/0482; G06F 3/0484; G06F 40/289; G06F 40/40

(52) U.S. Cl. CPC G06F 40/166; G06F 3/0482; G06F 3/0484; G06F 40/289; G06F 40/40

(57) ABSTRACT

A server displays a user interface configured to allow a user to enter and edit an electronic document. Responsive to receiving an indication from a user to generate starter text, the server presents one or more topics and one or more keywords related to the topic on the interface for selection. The server generates a prompt to a machine-learned language model. The prompt may specify at least the selected topic, the selected keywords, and a request to generate a set of candidate texts incorporating the selected topic and the selected keywords. For each candidate starter text, the server detects issues for mitigation in the candidate text to evaluate whether a degree of the detected issue in the candidate text is less than a predetermined threshold.

### BACKGROUND

### Field of Disclosure

The present invention generally relates to generating texts for an electronic document, and more specifically to an interface for generating texts using a large language model (LLM) and mitigating issues in the generated text.

### Description of the Related Art

Many electronic documents are drafted with the desired objective of providing feedback or inducing responses to the document from certain types of readers. For example, a performance feedback document is written with the objective of evaluating or assessing an employee's performance and providing actionable feedback and objectives for self-improvement. Large-scale machine-learned language models are transformer-based generative models that often have a significant number (e.g., millions, billions) of parameters and are trained based on a large amount of training data. These models can be used to generate text. However, often times, the training data for these models include issues such as bias that are also reflected in the generated text.

### SUMMARY

The above and other issues are addressed by a method, computer-readable medium, and a server for generating a user interface (UI) for allowing a user to insert text as starter text for an electronic document. An embodiment of the method comprises displaying a user interface (UI) configured to allow a user to enter and edit an electronic document. Responsive to receiving an indication from a user to generate text, the method comprises presenting one or more topics and one or more keywords related to the topic on the UI for selection. The method comprises generating a prompt to a machine-learned language model. The prompt may specify at least the selected topic, the selected keywords, and a request to generate a set of candidate texts incorporating the selected topic and the selected keywords. The method comprises receiving a response generated by executing the machine-learned language model on the generated prompt. For each candidate text, the method comprises detecting issues for mitigation in the candidate text and evaluating whether a degree of the detected issue in the candidate text is less than a predetermined threshold. The method also comprises generating a pane element on the UI to present the candidate texts and an evaluation of the candidate texts to the user. Responsive to receiving a selection of a candidate text, the method comprises inserting the candidate text into the UI.

### BRIEF DESCRIPTION OF DRAWINGS

FIG. 1 is a high-level block diagram illustrating an embodiment of an environment for a UI for generating texts using a large language model (LLM) and mitigating issues in the generated text, according to one embodiment.

FIG. 2 is a high-level block diagram illustrating an example computer for implementing the client device, the analysis server, and/or the posting server of FIG. 1.

FIG. 3 is a high-level block diagram illustrating a detailed view of the document analysis module of the analysis server, according to one embodiment.

FIGS. 4A-4F are example user interface screenshots for generating text as a starter text for an input document, according to one embodiment.

FIG. 5 is a flowchart illustrating a process of generating starter text for an input document, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

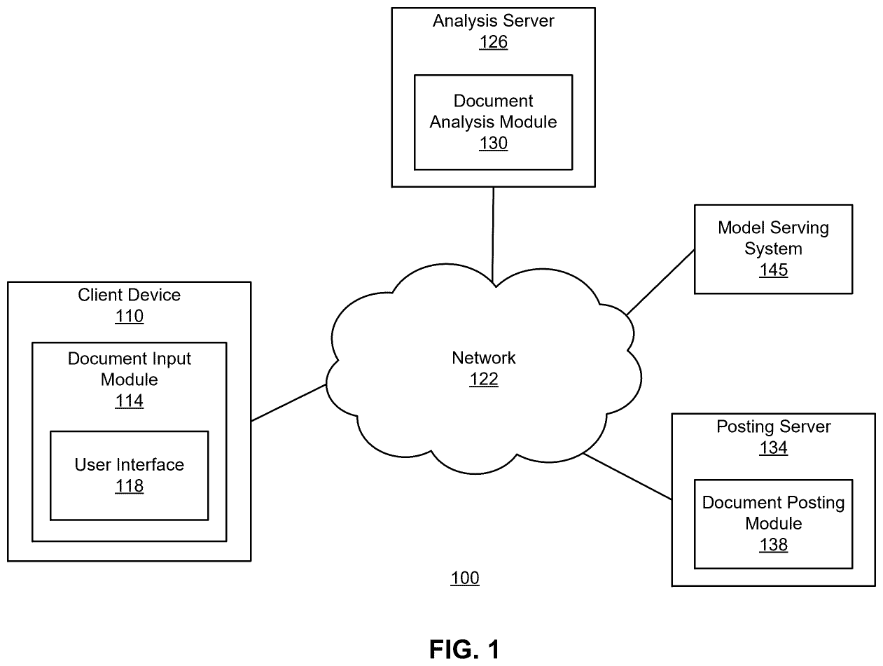

FIG. 1 is a high-level block diagram illustrating an environment 100 for optimizing a document to achieve its desired objectives, according to one embodiment. The environment 100 includes a client device 110 connected by a network 122 to an analysis server 126 and a posting server 134. Here only one client device 110, one analysis server 126, and one posting server 134 are illustrated but there may be multiple instances of each of these entities. For example, there may be thousands or millions of client devices 110 in communication with one or more analysis servers 126 or posting servers 134.

The network 122 provides a communication infrastructure between client devices 110, the analysis server 126, and the posting server 134. The network 122 is typically the Internet, but may be any network, including and not limited to a Local Area Network (LAN), a Metropolitan Area Network (MAN), a Wide Area Network (WAN), a mobile wired or wireless network, a private network, or a virtual private network.

The client device 110 is a computing device such as a smartphone with an operating system such as ANDROID® or APPLE® IOS®, a tablet computer, a laptop computer, a desktop computer, or any other type of network-enabled device. A client device 110 may include the hardware and software needed to connect to the network 122 (e.g., via Wi-Fi and/or 4G or other wireless telecommunication standards).

The client device 110 includes a document input module 114 that allows the user of the client device 110 to interact with the analysis server 126 and the posting server 134. The document input module 114 allows the user to input a document as formatted text, and forwards the document to the analysis server 126 or to the posting server 134 for posting to the computer network 122. The document input module 114 also allows the user to perform one or more tasks in conjunction with the analysis server 126 or presents any feedback data from the analysis server 126 or the posting server 134 back to the user of the client device 110. A client device 110 may also be used by a reader of a posted document to respond to the posting.

In one embodiment, the document input module 114 is configured within a browser that allows a user of the client device 110 to interact with the analysis server 126 and the posting server 134 using standard Internet protocols. In another embodiment, the document input module 114 includes a dedicated application specifically designed (e.g., by the organization responsible for the analysis server 126 or the posting server 134) to enable interactions among the client device 110 and the servers. In one embodiment, the document input module 114 includes a user interface 118 that allows the user of the client device 110 to edit and format the document and also presents feedback data about the document from the analysis server 126 or the posting server 134 to the client device 110.

Generally, the content of the document includes text written and formatted by an author directed towards achieving one or more desired objectives when presented to readers. A document may be classified into different types depending on its primary objective. For example, a document may be classified as a performance feedback document when the primary objective is to evaluate or assessing an employee's performance and provide actionable feedback. As another example a document may be classified as a recruiting document when the primary objective of the document is to gather candidates to fill a vacant job position at a business organization. As another example, the document may be classified as a campaign speech when the primary objective of the document is to relay a political message of a candidate running for government office to gather a high number of votes for an election.

The analysis server 126 includes a document analysis module 130 that displaying a user interface (UI) configured with a document editor to allow a user to enter and edit an electronic document. In one embodiment, the document analysis module 130 allows a user to request generation of texts to use as starter texts depending on the objective of the document. The document analysis module 130 may obtain candidate texts in conjunction with a large language model (LLM) hosted by the model serving system 145. The document analysis module 130 may evaluate the candidate texts for issues (e.g., bias) and indicate whether the candidate text is verified by the analysis server 126. The user can select a candidate text for insertion into the document editor as starter text for the document. In one embodiment, the selected text when inserted in the document editor can be further edited by the user. In another embodiment, the candidate texts are ready to use as-is, therefore, do not require further editing by the user. For example, the candidate texts or the starter text is rendered in display-only mode, such that the user can copy-paste the texts or share the text with other applications or users, rather than for the user to further edit the text.

Specifically, responsive to receiving an indication from a user to generate a starter text, the document analysis module 130 presents one or more topics and one or more keywords related to the topic for selection on the UI. The document analysis module 130 generates a prompt to a machine-learned language model (deployed on the model serving system 145). In one embodiment, the prompt specifies at least the selected topic, the selected keywords, and a request to generate a plurality of candidate starter texts incorporating the selected topic and the selected keywords. The document analysis module 130 receives, from the machine-learned language model, a response generated by executing the machine-learned language model on the prompt.

For each candidate starter text, the document analysis module 130 detects issues for mitigation or improvement in the candidate starter text by applying a set of defined features and evaluates whether a degree of the detected bias in the candidate starter text is less than a predetermined threshold. In one embodiment, the issues for mitigation are whether the generated text includes biased language with respect to one or more different categories. In one embodiment, the issues for mitigation are generally to improve effectiveness of the writing for the specific purpose of the electronic document. As an example, the set of features may also detect humor or language with legal risk in a performance feedback document that would be inappropriate for that type of document. However, it is appreciated that in some other embodiments, the issues for mitigation include other categories of issues that improve the effectiveness of the electronic document.

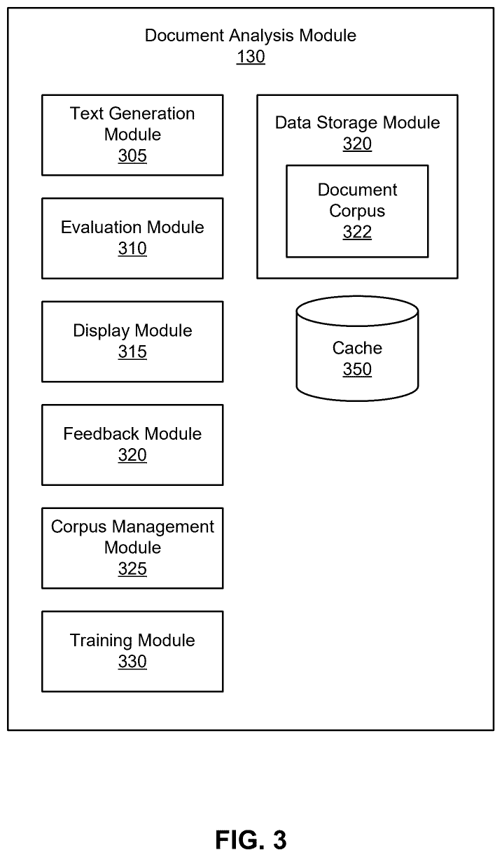

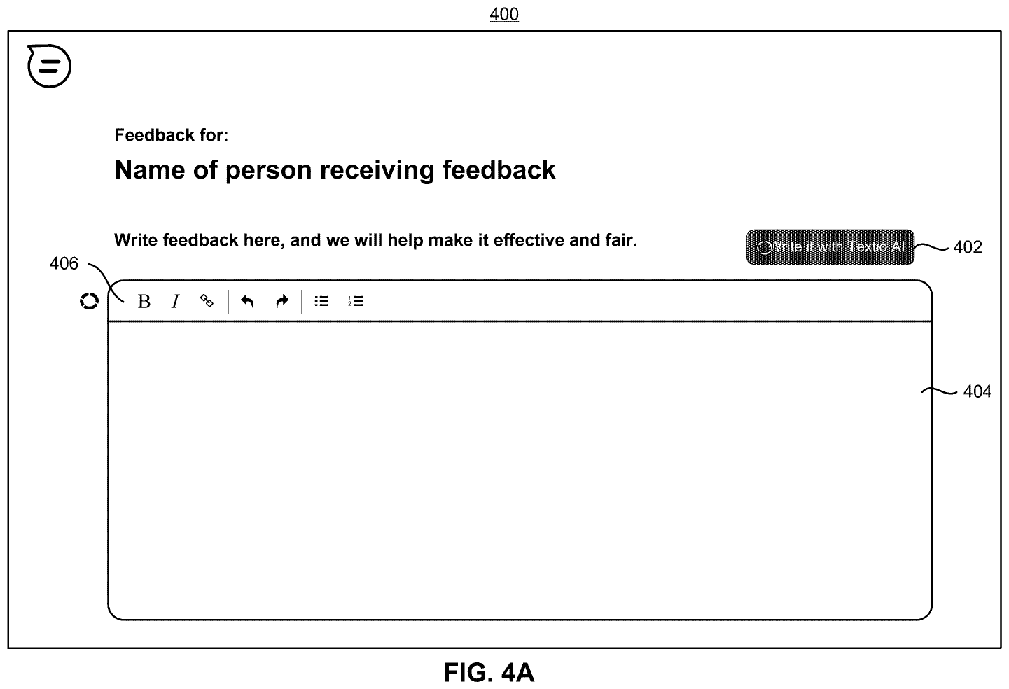

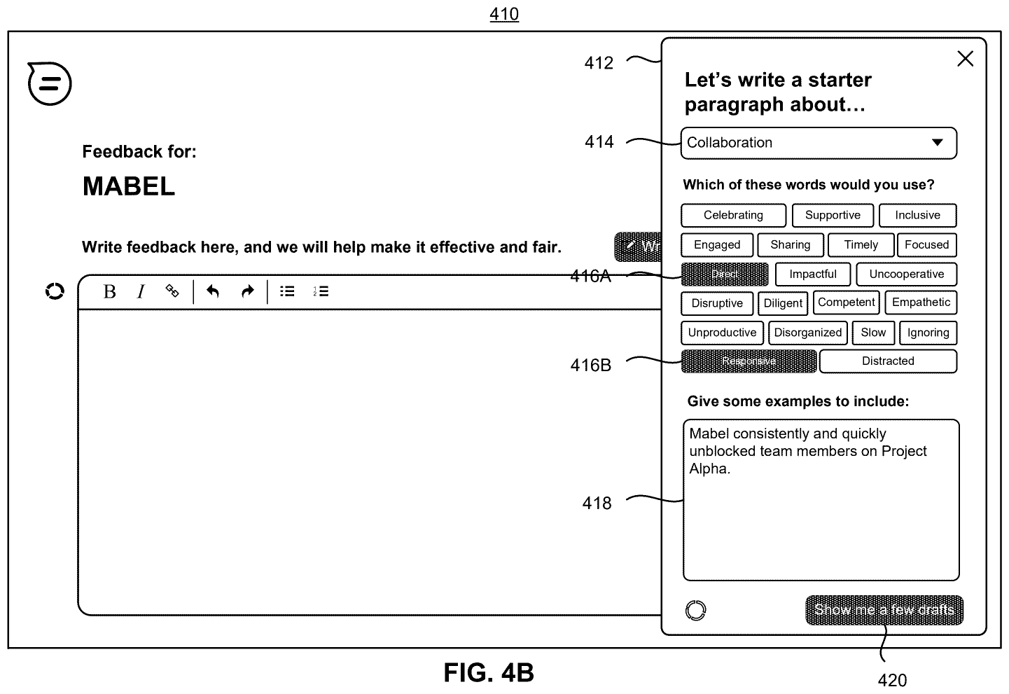

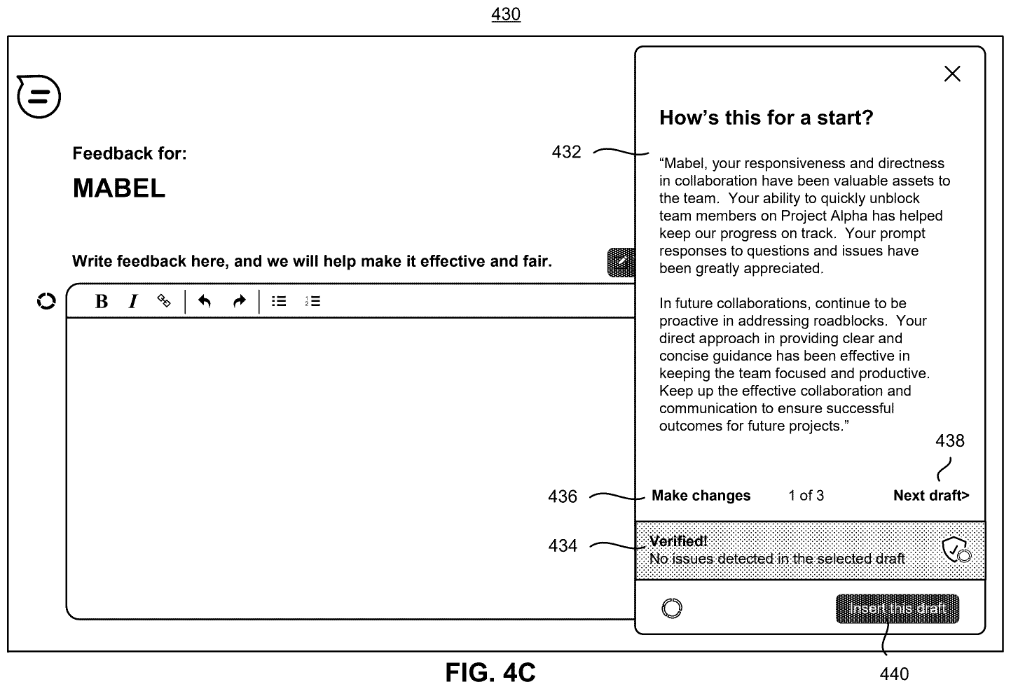

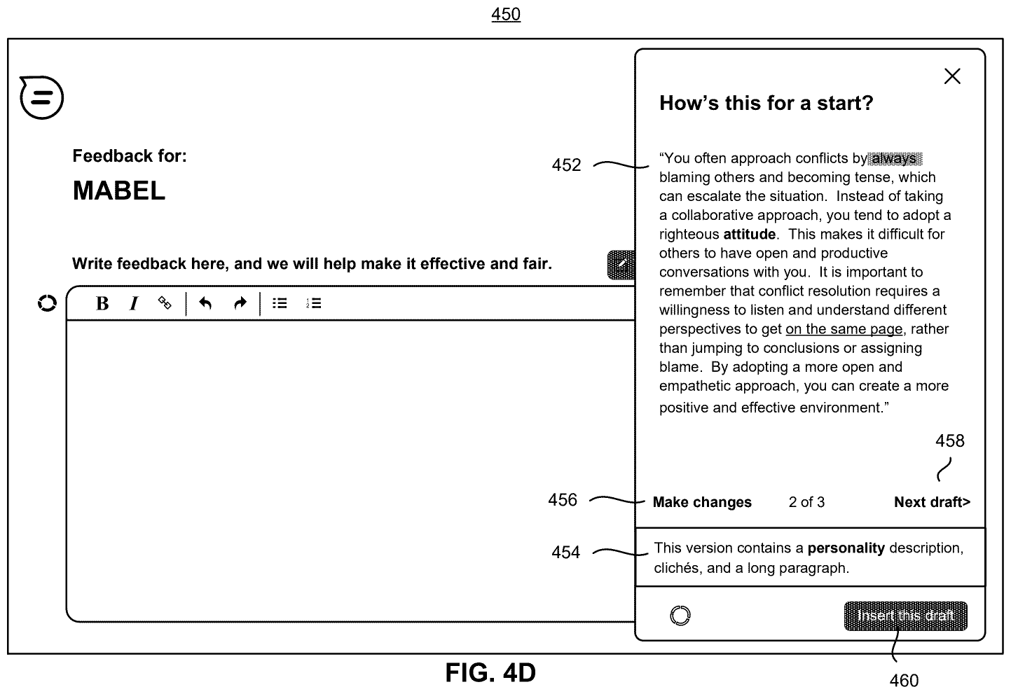

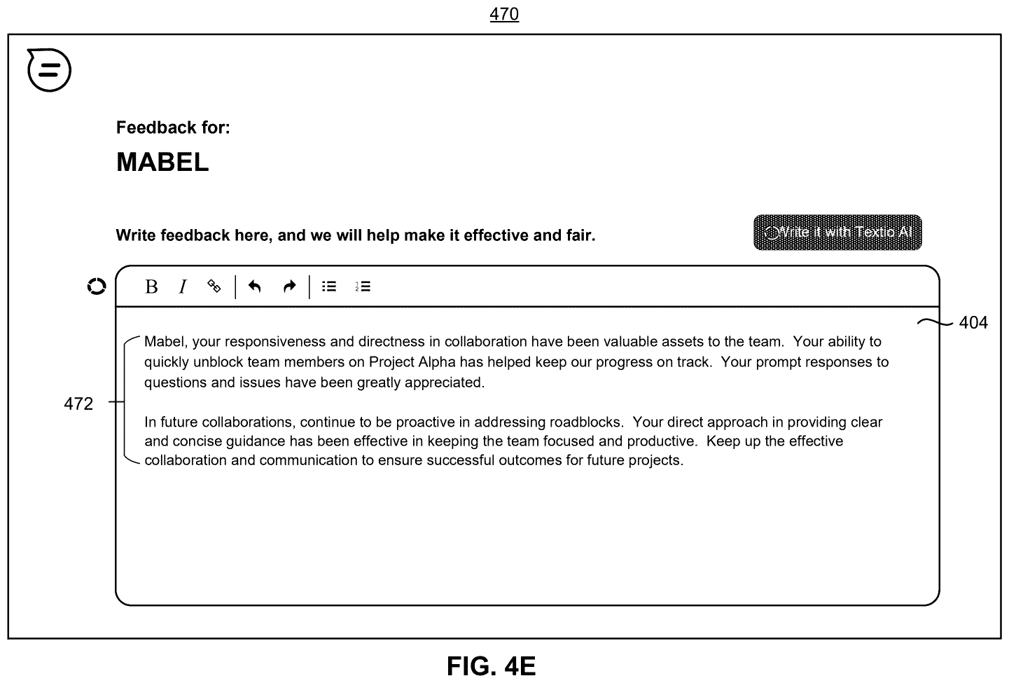

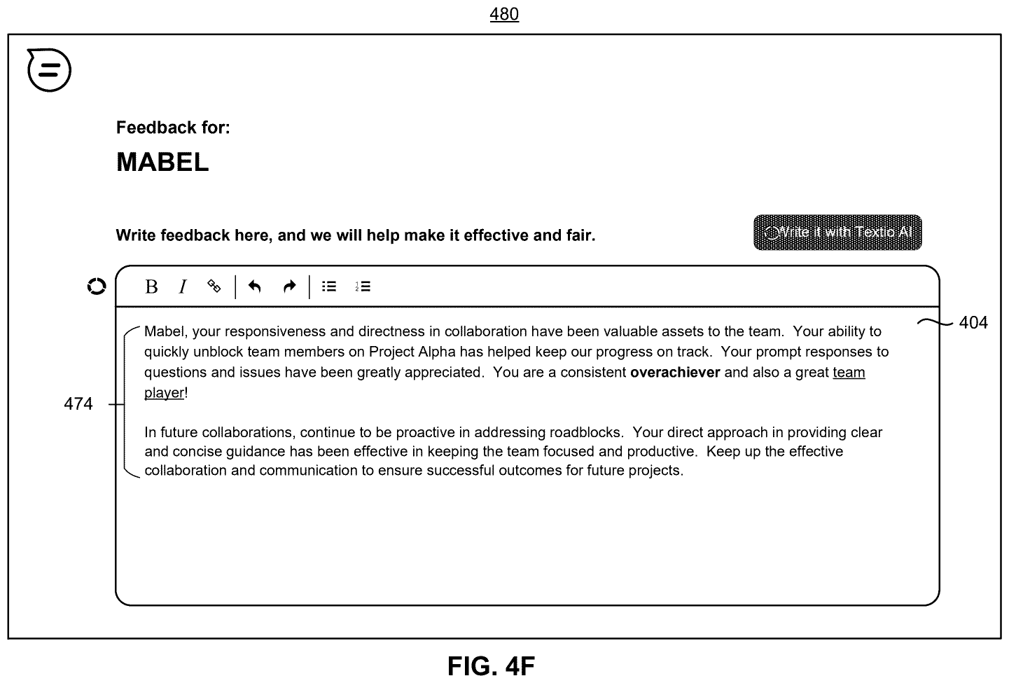

The document analysis module 130 generates an element (e.g., side pane element) on the user interface to present the candidate starter texts and the evaluation of the candidate starter texts to the user. Responsive to receiving a selection of a candidate starter text from the user, the document analysis module 130 inserts the candidate starter text into the document editor, such that the user can edit the electronic document. A more detailed description of this process is described below in conjunction with FIGS. 3 and 4A-4F.

The posting server 134 includes a document posting module 138 that posts the optimized document and receives outcome data on the optimized document. For example, the document posting module 138 may post a recruiting document optimized based on the evaluations received by the document analysis module 130. After the document has been posted, the document posting module 138 may receive applications for the posted position, as well as outcome data describing characteristics of people who responded to the document. The collected outcome data may be provided to the document analysis module 130 in order to refine evaluations on other documents, and also may be provided back to the client device 110.

The model serving system 145 deploys one or more machine-learned models. The model serving system 145 receives requests from the analysis server 126 to perform inference tasks using machine-learned models. The inference tasks include, but are not limited to, natural language processing (NLP) tasks, audio processing tasks, image processing tasks, video processing tasks, and the like. In one embodiment, the machine-learned models deployed by the model serving system 145 are models configured to perform one or more NLP tasks. The NLP tasks include, but are not limited to, text generation, query processing, machine translation, chatbot applications, and the like. In one embodiment, the language model is configured as a transformer neural network architecture. Specifically, the transformer model is coupled to receive sequential data tokenized into a sequence of input tokens and generates a sequence of output tokens depending on the inference task to be performed.

Specifically, the model serving system 145 receives a request including input data (e.g., text data, audio data, image data, or video data) and encodes the input data into a set of input tokens. The model serving system 145 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

The sequence of input tokens or output tokens are arranged as a tensor with one or more dimensions, for example, one dimension, two dimensions, or three dimensions. For example, one dimension of the tensor may represent the number of tokens (e.g., the length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one embodiment, the machine-learned models are large language models (LLMs) trained on a large corpus of training data to generate outputs for NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 10 billion, at least 100 billion, at least 1 trillion, at least 1.5 trillion parameters, and the like.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM is trained by the analysis server 126 or entities/systems different from the analysis server 126. An LLM may be trained on a large amount of data from various data sources.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations. The LLM is configured to receive a prompt and generate a response to the prompt. The prompt may include a task request and contextual information that is useful for responding to the prompt. The LLM infers the response to the prompt from the knowledge that the LLM was trained on and/or from the contextual information included in the prompt.

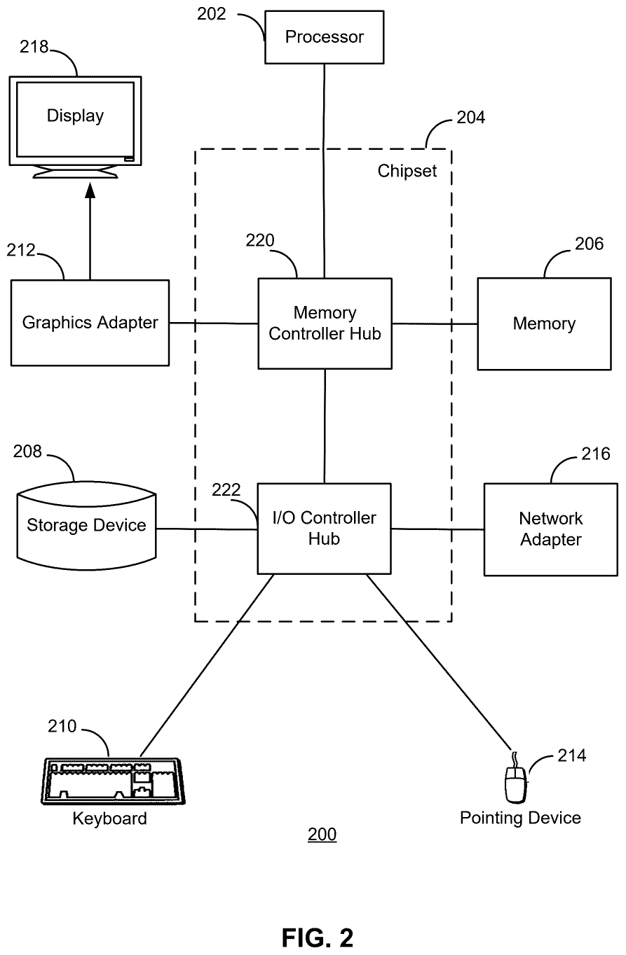

FIG. 2 is a high-level block diagram illustrating an example computer 200 for implementing the client device 110, the analysis server 126, model serving system 145, and/or the posting server 134 of FIG. 1. The computer 200 includes at least one processor 202 coupled to a chipset 204. The chipset 204 includes a memory controller hub 220 and an input/output (I/O) controller hub 222. A memory 206 and a graphics adapter 212 are coupled to memory controller hub 220, and a display 218 is coupled to the graphics adapter 212. A storage device 208, an input device 214, and network adapter 216 are coupled to the I/O controller hub 222. Other embodiments of the computer 200 have different architectures.

The storage device 208 is a non-transitory computer-readable storage medium such as a hard drive, compact disk read-only memory (CD-ROM), DVD, or a solid-state memory device. The memory 206 holds instructions and data used by the processor 202. The input interface 214 is a touch-screen interface, a mouse, track ball, or other type of pointing device, a keyboard, or some combination thereof, and is used to input data into the computer 200. The graphics adapter 212 displays images and other information on the display 218. The network adapter 216 couples the computer 200 to one or more computer networks.

The computer 200 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 208, loaded into the memory 206, and executed by the processor 202. The types of computers 200 used by the entities of FIG. 1 can vary depending upon the embodiment and the processing power required by the entity. The computers 200 can lack some of the components described above, such as graphics adapters 212, and displays 218. For example, the analysis server 126 can be formed of multiple blade servers communicating through a network such as in a server farm.

FIG. 3 is a high-level block diagram illustrating a detailed view of the document analysis module 130 of the analysis server 126, according to one or more embodiments. The document analysis module 130 comprises of modules including a data storage module 320, a text generation module 305, an evaluation module 310, a display module 315, a feedback module 320, a corpus management module 325, and a training module 330. Some embodiments of the document analysis module 130 have different modules than those described here. Similarly, the functions can be distributed among the modules in a different manner than is described here.

The text generation module 305 receives an indication from the user (e.g., user clicking on a button on the UI) to generate starter text for an electronic document and obtains candidate texts in conjunction with the model serving system 145. In one embodiment, depending on the category of the input document (e.g., performance feedback, recruiting document), the text generation module 305 generates one or more candidate topics and one or more candidate keywords related to each topic. As an example, candidate topics for a performance feedback document may include leadership, collaboration, creativity, discipline, and the like. As an example, candidate keywords for the topic collaboration may include celebrating, supportive, inclusive, engaged, responsive, timely, and the like. As another example, candidate keywords for the topic leadership may include strategic, decisive, mentoring, committed, and the like.

The text generation module 305 provides the candidate topics and keywords for display to the display module 315. The text generation module 305 then receives an indication that the user selected a topic and one or more keywords related to the topic. The indication may be an indication the user interacted with one or more UI elements. The text generation module 305 may also receive specific examples to include in the starting text from the user. The examples provided by the user may describe specific instances to include in the starter text. For example, an example submitted by a user on the topic leadership may be “[y]ou led 8 meetings this week alone that brought together different colleagues to lead this project.” An example UI is described below in more detail in conjunction with FIG. 4B.

The text generation module 305 generates a prompt to a machine-learned language model (e.g., LLM) hosted on the model serving system 145. In one embodiment, the text generation module 305 includes one or a combination of five components in the prompt. The first component is the preamble that describes the task. For example, the prompt may be: “[y]ou are writing actionable feedback for a coworker or employee named Mabel Smith who is a female engineer and can be contacted at mabel@fakeemail.com, her manager is Barry Berry who can be contacted at barry@fakeemail.com . . . [f]ollowing the rules below, write one or two paragraphs.”
The second component is the topic the user selected which is defined and appended to the prompt. For example, the prompt may further include:
“[w]rite one or two paragraphs about leadership: being a leader.”
The third component is the set of keywords the user selected which are appended to the prompt.
For example, the prompt may further include:
“[a]djectives describing the employee's performance: innovative, listening, thoughtful.”
The fourth component is the example from the user. For example, the prompt may further include:
“[i]nclude the following information in these supporting examples—Mabel led 8 meetings this week alone that brought together different colleagues to lead this project and showed proactiveness.”
The fifth component are rules to follow to ensure the generated text does not have problems or issues that should be mitigated, for example, biased language. For example, the prompt may further include:
“[n]o introduction, use a second person point of view, use short paragraphs less than 30 words.”

The text generation module 305 provides the prompt to model serving system 145 for execution. In one embodiment, the text generation module 305 invokes an application programming interface (API) call to the model serving system 145 and provides the prompt as the parameters in the API call. In one instance, the API call is configured as a REST API protocol, a RPC call, or a gRPC call. The text generation module 305 receives a response to the prompt based on the execution of the prompt with a machine-learned model (e.g., using one or more GPU devices). In one embodiment, the response includes candidate starter texts that were generated based on the prompt.

The text generation module 305 provides the candidate texts to the evaluation module 310 for evaluation. The evaluation for a candidate text includes at least an evaluation score that indicates the degree of issues in the candidate text, more specifically, a degree of biased language detected in the candidate text. In addition to the scores, the evaluation for the candidate starter text may include a verification that the score is below a predetermined threshold, indicating that the text has minimal biased language. The text generation module 305 provides the evaluated candidate texts to the display module 315 for display to the user, such that the user can select a candidate starter text to insert in the document editor of the UI. In one embodiment, the text generation module 305 generate text until there is at least a threshold number of verified results. For example, the text generation module 305 generates candidate text until at least three candidate texts that are verified is generated. An example UI is described below in more detail in conjunction with FIGS. 4C-4D.

In one embodiment, the text generation module 305 further performs a masking process to mask personal identifiable information (PII) in the prompt in the case a user writes PII into the unstructured text before the prompt is provided to the model serving system 145. In one embodiment, the text generation module 305 applies a named entity recognition (NER) model or software to the created prompt to detect entities such as person names, telephone numbers, addresses, and the like. For example, in the example prompt above, the initial prompt includes person names “Mabel Smith” and “Barry Berry,” and emails “mabel@fakeemail.com” and “barry@fakeemail.com.”

Depending on the recognized entity, the text generation module 305 identifies PII's by identifying recognized entities that are unique strings. The text generation module 305 creates numbered placeholder entities and stores the PII unique strings with their corresponding placeholders as key-value pairs (e.g., stored in the cache 350). For example, the text generation module 305 may map “Mabel Smith” to placeholder entity PERSON_1 and “Barry Berry” to placeholder entity PERSON_2, and map email “mabel@fakeemail.com” to placeholder entity EMAIL_1 and email “barry@fakeemail.com” to placeholder entity EMAIL_2. Therefore, the revised example prompt may be given as:
“[y]ou are writing actionable feedback for a coworker or employee named {PERSON 1} who is a female engineer and can be contacted at {EMAIL_1}, her manager is {PERSON_2} who can be contacted at {EMAIL_2} . . . [f]ollowing the rules below, write one or two paragraphs. [w]rite one or two paragraphs about leadership: being a leader. [a]djectives describing the employee's performance: innovative, listening, thoughtful.
[i]nclude the following information in these supporting examples—{PERSON_1} led 8 meetings this week alone that brought together different colleagues to lead this project and showed proactiveness. [n]o introduction, use a second person point of view, use short paragraphs less than 30 words.”

The text generation module 305 submits the masked prompt to the model serving system 145. After execution, the text generation module 305 receives candidate texts generated by the model serving system 145 and performs a de-masking process by retrieving each placeholder entity in the key-value store with the corresponding unique string and replacing the placeholder entity with the retrieved string. The de-masked outputs can be then presented to the user.

In some instances, the model serving system 145 may be managed by the entity responsible for the analysis server 126 or a different entity. When the model serving system 145 is managed by another entity, providing prompts with PII may expose sensitive information, therefore, the masking process allows the analysis server 126 to scrub the PII before sending the prompt to the model serving system 145. Moreover, the model is executed on a computer machine and parameters of the machine-learned model may initially be trained on training data that includes various sources of bias (e.g., webpages, articles, messages, and the like). PII may expose bias such as gender bias, geographical bias, socioeconomic bias, and so on that the model has learned from the training data. Thus, by replacing PII's with placeholder entities, the text generation module 305 can obtain relatively unbiased outputs from a pretrained model.

The evaluation module 310 evaluates text to generate an evaluation on whether the text has one or more issues that need mitigation or improvement with respect to the objective of the electronic document. In one embodiment, the issues for mitigation are whether the text includes bias. In one embodiment, the evaluation module 310 applies a set of features to each sentence of the text that detects the presence of a set of categories of bias in the sentence. In one embodiment, the features include features for detecting offensive language, harmful or potentially harmful language, insults, long sentences, long paragraphs, cliches, discriminatory language, exaggerations, fixed mindset languages, jargons, and language characterizing personality. In one embodiment, the evaluation module 310 assigns an impact score to each category when the feature for the category recognizes bias for that category.

In one embodiment, features that are generated via a rule-based process may include three or more categories of rules including at least exclusionary phrasing that should not be highlighted in the text, matching against different linguistic surface forms of the word, and matching against parts of speech. In one embodiment,
the feature for detecting offensive language is a rule-based process that applies one or more rules to detect presence of offensive language in the text and has a high impact score (e.g., 50 points); in one embodiment, the process applies the three or more rules to detect presence of offensive language,
the feature for detecting harmful or potentially harmful language is a rule-based process that applies one or more rules to detect presence of harmful or potentially harmful language in the text and has a moderate impact score (e.g., 20 points); in one embodiment, the process applies the three or more rules to detect presence of harmful or potentially harmful language,
the feature for detecting insults is a machine-learned model based process that applies a machine-learned model (e.g., via API call) to detect presence of insults in the text and has a high impact score (e.g., 50 points),
the feature for detecting long sentences is a rule-based process that applies one or more rules to detect presence of long sentences in the text and has a low impact score (e.g., 4 points),
the feature for detecting long paragraphs is a rule-based process that applies one or more rules to detect presence of long paragraphs in the text and has a low impact score (e.g., 4 points),
the feature for detecting cliches is a rule-based process that applies three or more rules to detect presence of cliches in the text and has a low impact score (e.g., 4 points); in one embodiment, the process applies the three or more rules to detect presence of cliches in the text,
the feature for detecting discriminatory language is a machine-learned model based process that applies a machine-learned model (e.g., via API call) in conjunction with three or more rules to detect presence of discriminatory language in the text and has a high impact score (e.g., 50 points),
the feature for detecting exaggerations is a rule-based process that applies one or more rules to detect presence of exaggerations in the text and has a low impact score (e.g., 4 points); in one embodiment, the process applies the three or more rules to detect presence of exaggeration in the text,
the feature for detecting fixed mindset languages is a rule-based process that applies one or more rules to detect presence of fixed mindset languages in the text and has a low impact score (e.g., 4 points); in one embodiment, the process applies the three or more rules to detect presence of fixed mindset languages,
the feature for detecting jargons is a rule-based process that applies one or more rules to detect jargons in the text and has a low impact score (e.g., 4 points); in one embodiment, the process applies the three or more rules to detect presence of jargons, and
the feature for detecting language characterizing personality is a machine-learned model based process that applies a machine-learned model (e.g., via API call) in conjunction with three or more rules to detect the presence of language characterizing personality in the text and has a low impact score (e.g., 4 points).

As an example, for the example text:
“This will ensure that everyone is on the same page and prevent any potential misunderstandings. [Sentence 1] Additionally, consider diversifying your communication methods to cater to different preferences and situations. [Sentence 2] Overall, your strong communication skills contribute to a productive work environment. [Sentence 3]”,
the evaluation module 310 may apply the set of features and determine that the phrase “is on the same page” is a cliché via multiple rules that match against a dictionary of known cliches. The rules will highlight and flag any variations of cliches in the text.

The evaluation module 310 generates the evaluation score for each candidate starter text by combining the impact scores for each detected category of bias in the text. The evaluation module 310 may also provide a verification to a respective candidate text if the total evaluation score for the candidate text is below a predetermined threshold (e.g., 4 points or less). For each candidate starter text, the evaluation module 310 provides the evaluation, including the evaluation score and any verification to the text generation module 305, such that the text generation module 305 can provide the results for display. However, it is appreciated that in other embodiments, the impact scores and evaluation scores may be deemed relatively less unbiased if the values are higher.

In one embodiment, as described in further detail below in conjunction with FIG. 4F, the user may edit the electronic document using a document editor (e.g., after a selected starter text is inserted into the document editor), and the evaluation module 310 may receive the input document and apply the set of features to each sentence of the input document to determine the presence of one or more categories of bias as described above. In one instance, as the analysis server 126 is configured as a computer system, the evaluation module 310 continuously receives contents of the electronic document as the user is revising the electronic document on the user interface 118, so that the results of the evaluation can be continuously updated real-time in the background.

In one embodiment, the analysis server 126 configures a cache 350 data store that stores the results of bias detection for each sentence in the input document for the user. For example, the evaluation module 310 may store in the cache 350 that Sentence 1 has a cliché for the phrase “is on the same page,” Sentence 2 has no issue, and Sentence 3 has no issue. When the user further revises the input document to modify an existing sentence or add an additional sentence, the evaluation module 310 does not require re-processing of sentences that remain the same after the edit. For example, when the user modifies Sentence 2 in the example above, the evaluation module 310 may only process the modified version of Sentence 2 by applying the set of features to the modified sentence to detect the word “always” is a exaggeration issue. “This will ensure that everyone is on the same page and prevent any potential misunderstandings. [Sentence 1] Additionally, consider diversifying your communication methods to always cater to different preferences and situations. [Modified Sentence 2] Overall, your strong communication skills contribute to a productive work environment. [Sentence 3]”,

In one embodiment, the cache 350 is an in-memory cache that resides in memory, which enables low latency and high throughput data access. In another embodiment, the cache 350 is a persistent data store in cloud storage or disk. The in-memory cache 350 may also be configured as a key-value data store, in which data is fetched using a unique key or a number of unique keys to retrieve the associated value with each key. In one instance, a key is a hash of each sentence (e.g., generated by applying SHA-256 function to the text of the sentence) and the value describes the detected issues in the sentence of the electronic document. In particular, users of the analysis server 126 may continuously update the input document. If the evaluation module 310 were to process each sentence using the set of features each time the input document was changed, the computational latency would increase. For example, rule-based features may have to apply complex rules to each sentence of the document and machine-learned model based features may have to invoke multiple API calls for different machine-learned models to determine the presence of certain issues. By storing the data in the cache 350, the sentences that already have been evaluated and processed by the evaluation module 310 do not need to be re-processed, saving computational resources and improving latency.

The display module 315 generates a UI displayed on the client device 110. The UI includes a document editor that allows a user to input text, and revise and edit the document through the user interface 118 to improve its likelihood of achieving its set of objectives. In one embodiment, the display module 315 generates or renders a component on the UI that when interacted with by the user, triggers the process of generating starter texts for the input document.

FIG. 4A is an example user interface 400 for displaying a UI for creating and editing an electronic document, in accordance with an embodiment. The UI may correspond to the user interface 118 generated by the display module 315 on the client device 110. As shown in the example of FIG. 4A, the UI includes a document editor 404 as a text box for the user to enter and revise an electronic document. The UI also includes a toolbox 406 allowing the user to select different styles for the text or different functionalities when editing the document. The example interface also includes a button 402 labeled “Write it with Textio AI,” that when clicked by the user, initiates the process of generating candidate starter texts for the user.

Responsive to interaction with the UI component, the display module 315 receives one or more candidate topics and one or more candidate keywords related to the topics from the text generation module 305. The display module 315 presents the candidate topics and keywords to the user for selection. In one embodiment, the display module 315 presents the candidate topics using a dropdown UI component that when clicked by the user, is configured to show the candidate topics. Responsive to receiving a selection on a topic, the display module 315 presents the candidate keywords related to the selected topic. In one embodiment, the display module 315 presents the candidate keywords using one or more selection chips that allow the user to click on multiple selections. In one embodiment, the display module 315 also renders a field on the user interface 118 that allows the user to enter specific examples that should be incorporated into the starter text, for example, specific examples of the employee being assessed of when the employee demonstrated collaboration.

FIG. 4B is an example user interface 410 for displaying a pane element 412 for presenting candidate topics and keywords and a text field for inserting examples for the starter text, in accordance with an embodiment. As shown in the example in FIG. 4B, the display module 315 generates a pane element 412 overlaid on the document editor. The pane element 412 includes a dropdown element 414 for presenting the candidate topics (related to a performance feedback document for an employee “Mabel” in this example). Responsive to the user selecting the “Collaboration” topic, the display module 315 presents one or more selection chips that are each labeled with a respective keyword related to the selected topic. As an example, the keywords “Direct” and “Responsive” are selected by the user. The display module 315 renders a text field 418 within the pane element 412 that allows a user to enter specific examples for the starter text. In the example shown in FIG. 4B, the user enters an example of when the employee had demonstrated collaboration with team members. The display module 315 additionally generates a button 420 that when clicked by the user, initiates the text generation process.

The selected topics, keywords, and examples are provided to the text generation module 305. The text generation module 305 generates the prompts for execution by the machine-learned model of the model serving system 145 and obtains candidate starter texts, as described in conjunction with the text generation module 305 above. In addition, the candidate starter texts are evaluated by the evaluation module 310 to obtain evaluation scores and any verifications for the candidate texts, as described in conjunction with the evaluation module 310 above. The display module 315 receives the candidate starter texts and the evaluations and displays the candidate starter texts to the user.

FIGS. 4C-4D are example user interfaces 430, 450 for displaying candidate starter texts with verifications, in accordance with an embodiment. As shown in FIG. 4C, the display module 315 receives three candidate starter texts and their evaluations from the text generation module 305. The display module 315 presents the first candidate starter text 432 on the pane element. In particular, if the candidate starter text is verified because the evaluation score is less than a predetermined threshold, the display module 315 also displays an indication on the user interface 118, as shown in element 434. Moreover, the user interface 118 includes a button 436 that when clicked by the user, allows the user to edit the text within the pane element. The user interface 118 also includes a toggle button 436 that allows the user to toggle through other candidate starter texts.

As shown in FIG. 4D, when the user clicks on the toggle button 436, the display module 315 displays the next candidate starter text within the pane element. In one embodiment, the evaluations for each candidate starter text include the different categories of bias that were detected in the text by applying the set of features. The display module 315 presents the second candidate starter text 452 in the pane element. In addition, the evaluation of the second candidate text may include results that the word “always” includes an exaggeration bias, the word “attitude” includes characterization of personality (rather than work), and the phrase “on the same page” includes cliché language. The display module 315 also generates indications over the candidate starter text to highlight or flag these issues to the user. In one instance the indications are generated using different colors per category of bias detected, different patterns per category of bias detected, and the like. As an example, “always” is highlighted with a dotted pattern, “attitude” is bolded, and “on the same page” is underlined using different patterns to annotate the different categories of bias. Since the second candidate starter text is not verified, the display module 315 does not present a verification but rather an indication 454 describing the various issues in the text.

The display module 315 may receive a selection from the user on a candidate text by, for example, the user clicking on the “Insert this draft” button on the user interface 118. Responsive to receiving the interaction from the user, the display module 315 inserts the text of the selected candidate starter text into the document editor. In one embodiment, the display module 315 may store the text of the selected candidate starter text in a custom state and set the value of the content of the document editor component as the text in the custom state. In one embodiment, any annotations (of detected bias categories) may also be displayed on the document editor after the selected text is inserted into the editor.

FIG. 4E is an example user interface 470 for inserting a selected starter text into the document editor, in accordance with an embodiment. As shown in FIG. 4E, responsive to the user selecting the first candidate starter text and clicking on the button 440, the text of the first candidate starter text is inserted 472 into the input field 404 of the document editor, such that the user can use the text as a starting point for the performance feedback document.

FIG. 4F is an example user interface 480 for revising the starter text in the document editor and providing evaluations, in accordance with an embodiment. Moreover, as described in conjunction with the evaluation module 310, the display module 315 may continuously provide the document as the user revises and edits the electronic document using the document editor. As shown in FIG. 4F, the user has added a sentence at the end of the first paragraph, “[y]ou are a consistent overachiever and also a great team player!”

The display module 315 provides the revised text 474 of the document to the evaluation module 310, such that the evaluation module 310 may process each sentence to detect different categories of bias. The evaluation module 310 may hash each sentence and store the results of bias detection in the cache 350. The display module 315 receives the evaluations and annotates portions of the electronic document within the document editor 404 to reflect the results. In particular, the phrase “overachiever” characterizes personality rather than work and the phrase “team player” is a cliché. The display module 315 annotates these phrases on the user interface 118 using different patterns or colors of indicators, such that the user can view the detected issue when, e.g., the mouse cursor hovers over the indication.

When the user again revises or edits the document and, for example, adds a sentence to the second paragraph, the evaluation module 310 can retrieve the sentences remaining the same from the in-memory cache 350 without separately processing the sentences again, and only process the additional new sentence. The display module 315 may additionally present any detected issues in the new sentence in addition to the existing detections. In this way, the latency of obtaining evaluations can be improved even when the electronic document is being frequently edited.

Returning to the document analysis module 130, the feedback module 320 may obtain data from users on the generated text obtained by the text generation module 305. In one instance, as described in further detail below, the feedback is used to construct a training dataset for training or fine-tuning parameters of the LLM to generate improved text based on the feedback. In one instance, the feedback module 320 determines that given a prompt created using the selected topics and keywords and the examples, a candidate starter text received positive feedback if the candidate starter text was selected and inserted in the document editor, or the candidate starter text is similar with the final document posted on the posting server 134 (e.g., final assessment sent to employee) above a given threshold.

In other embodiments, the feedback module 320 may generate one or more UI components (e.g., like or dislike buttons, thumbs up or thumbs down buttons) on the user interface 118 and receive a positive indication of the candidate starter text if the user (e.g., writer or reader of the document) clicked on the like button or the thumbs up button, or receive a negative indication of the candidate text if the user (e.g., writer or reader of the document) clicked on the dislike button or the thumbs down button. The text that received positive feedback are indicative that the document will achieve the desired objective of being an unbiased document for a purpose and can be used as training data to further train or fine-tune parameters of the machine-learned model.

The data storage module 320 stores data used by the document analysis module 130. The data include a document corpus 322. The document corpus 322 is a collection of documents that are presented to readers and are associated with a set of known outcomes or feedback.

The corpus management module 325 generates, maintains, and updates the document corpus 322. The corpus management module 325 collects documents in the document corpus 322, as well as their outcomes, from various sources. In one instance, the corpus management module 325 collects documents previously posted and presented to readers and have a set of known outcomes. These documents may include documents posted, and corresponding outcome data received, by the posting server 134. In one embodiment, the corpus management module 325 collects a set of data instances, where a data instance includes previous instances of prompts generated using selected topics and keywords and examples submitted by a user, and candidate starter texts that were generated by the machine-learned model (or text further modified by the user staring from the selected candidate text) that received positive feedback. Therefore, the set of data instances include multiple pairs of (prompt, positive text), in which the positive text is text determined to have received positive feedback. The training data may be stored in the document corpus store 322.

The training module 330 trains or further fine-tunes parameters of the machine-learned models deployed by the model serving system 145 based on the created training dataset. In one embodiment, the training module 330 obtains the pairs of prompts and positive text in the training dataset. The training module 330 encodes the pair into a set of input tokens, where a token is a numerical vector representing a word, sub-word, phrase in a latent space. When the transformer architecture of the machine-learned model (e.g., LLM) is an autoregressive architecture, the LLM may be applied to generate one or more output tokens that correspond to the positive text. An output token is decoded to determine a probability that the decoded token corresponds to a corresponding token in the positive text.

The training module 330 determines a loss function across the one or more output tokens that indicates a difference (e.g., logit difference) between the tokens in the positive text and the output tokens generated by the forward pass of the transformer model. As an example, the loss function may be an NLP loss for each token combined across one or more output tokens generated for the positive text. The training module 330 obtains one or more terms from the loss function and performs backpropagation to update parameters of the transformer architecture. After the model has been trained or fine-tuned, the candidate texts generated using the updated model may be presented to the user and feedback may be obtained for these new candidate texts. The newly obtained feedback may be used to reconstruct the training dataset and the parameters of the machine-learned model may be continuously refined as more feedback is obtained.

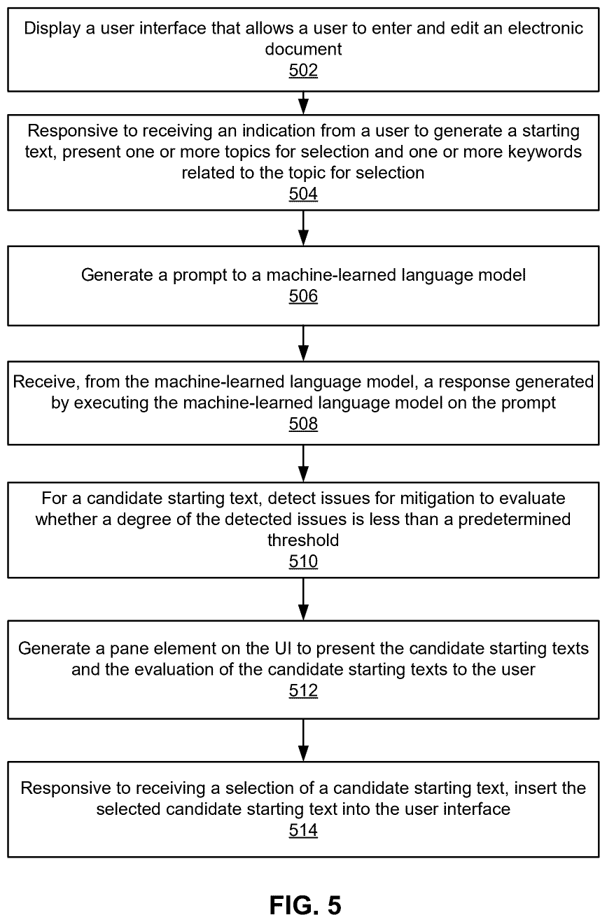

FIG. 5 is a flowchart illustrating a process of generating a starter text for an input document, according to one embodiment. In one embodiment, the process of FIG. 5 is performed by the analysis server 126. Other entities may perform some or all of the steps of the process in other embodiments. Likewise, embodiments may include different and/or additional steps, or perform the steps in different orders.

The analysis server 126 displays 502 a user interface configured with an editor to allow a user to enter and edit an electronic document. Responsive to receiving an indication from a user to generate starting text, the analysis server 126 presents 504 one or more topics and one or more keywords related to the topics for selection. The analysis server 126 generates 506 a prompt to a machine-learned language model. The prompt may specify at least the selected topic, the selected keywords, and a request to generate a set of candidate starter texts incorporating the selected topic and the selected keywords of the user. The analysis server 126 receives 508, from the machine-learned language model, a response generated by executing the machine-learned language model on the prompt.

For a candidate starter text, the analysis server 126 detects 510 issues for mitigation in the candidate starting text to evaluate whether a degree of the detected issues in the candidate starting text is less than a threshold. The analysis server 126 generates 512 a pane element (sends code that causes the pane element to be generated) on the user interface to present the candidate starting texts and an evaluation of the candidate starter texts to the user. Responsive to receiving a selection of a candidate starter text, the analysis server 126 inserts 514 the selected candidate starter text as an input document into the editor of the user interface.

### Other Considerations

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for generating evaluations of documents based on one or more outcomes of the document. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein.

1. A computer-implemented method, comprising:
displaying a user interface configured with an editor to allow a user to enter and edit an electronic document;
responsive to receiving an indication from a user to generate starting text, presenting one or more topics and one or more keywords related to the topics for selection;
generating a prompt to a machine-learned language model, the prompt specifying at least the selected topic, the selected keywords, and a request to generate a set of candidate starter texts incorporating the selected topic and the selected keywords of the user;
receiving, from the machine-learned language model, a response generated by executing the machine-learned language model on the prompt;
for a candidate starter text, detecting issues for mitigation in the candidate starting text to evaluate whether a degree of the detected issues in the candidate starting text is less than a predetermined threshold;
generating a pane element on the user interface to present the candidate starting texts and an evaluation of the candidate starter texts to the user; and
responsive to receiving a selection of a candidate starter text, inserting the selected candidate starter text as an input document into the editor of the user interface.

2. The computer-implemented method of claim 1, wherein detecting issues for mitigation in the candidate starter text further comprises:
applying a set of features to the candidate starter text, wherein a feature corresponds to detection of a respective category of bias, and wherein applying the feature to the candidate starter text generates an impact score for the category of bias;
generating an evaluation score for the candidate starter text by combining impact scores across the set of features; and
determining whether the evaluation score is less than the predetermined threshold.

3. The computer-implemented method of claim 2, further comprising:
identifying one or more phrases in the candidate starter text that are detected to have text with one or more categories of bias; and
for each identified phrase, generating indications over the phrases on the user interface associated with the category of bias for the identified phrase.

4. The computer-implemented method of claim 1, further comprising:
evaluating each sentence of one or more sentences of the input document and storing the evaluations of the one or more sentences in a cache storage;
receiving an indication the user modified an existing sentence or added a new sentence to the input document;
evaluating the modified sentence or the new sentence of the input document;
presenting the evaluation of the modified sentence or the new sentence in the editor; and
retrieving the evaluations of sentences that are unchanged from the cache storage without reevaluating the unchanged sentences.

5. The computer-implemented method of claim 1, presenting the one or more topics and the one or more keywords further comprises:
presenting a dropdown element including the one or more topics; and
responsive to receiving the selected topic, presenting the one or more keywords as selection chips on the user interface.

6. The computer-implemented method of claim 1, further comprising:
providing the prompt to the model serving system via an API call to an endpoint of the model serving system, wherein the API call follows one or a combination of a REST API communication protocol, a RPC protocol, or a gRPC protocol.

7. The computer-implemented method of claim 1, generating the prompt further comprises:
identifying one or more pieces of personal identifiable information (PII) entities in the prompt;
identifying one or more placeholder entities for the one or more PII entities;
generating a modified prompt by replacing the PII entities with respective placeholder entities; and
responsive to receiving the response, replacing the placeholder entities with the respective PII entities in the response.

8. A non-transitory computer-readable storage medium storing executable computer program instructions, the computer program instructions when executed causes one or more processors to:
display a user interface configured with an editor to allow a user to enter and edit an electronic document;
responsive to receiving an indication from a user to generate starting text, present one or more topics and one or more keywords related to the topics for selection;
generate a prompt to a machine-learned language model, the prompt specifying at least the selected topic, the selected keywords, and a request to generate a set of candidate starter texts incorporating the selected topic and the selected keywords of the user;
receive, from the machine-learned language model, a response generated by executing the machine-learned language model on the prompt;
for a candidate starter text, detect issues for mitigation in the candidate starting text to evaluate whether a degree of the detected issues in the candidate starting text is less than a predetermined threshold;
generate a pane element on the user interface to present the candidate starting texts and an evaluation of the candidate starter texts to the user; and
responsive to receiving a selection of a candidate starter text, insert the selected candidate starter text as an input document into the editor of the user interface.

9. The non-transitory computer-readable storage medium of claim 8, wherein the computer program instructions when executed further causes the one or more processors to:
apply a set of features to the candidate starter text, wherein a feature corresponds to detection of a respective category of bias, and wherein applying the feature to the candidate starter text generates an impact score for the category of bias;
generate an evaluation score for the candidate starter text by combining impact scores across the set of features; and
determine whether the evaluation score is less than the predetermined threshold.

10. The non-transitory computer-readable storage medium of claim 9, wherein the computer program instructions when executed further causes the one or more processors to:
identify one or more phrases in the candidate starter text that are detected to have text with one or more categories of bias; and
for each identified phrase, generate indications over the phrases on the user interface associated with the category of bias for the identified phrase.

11. The non-transitory computer-readable storage medium of claim 8, wherein the computer program instructions when executed further causes the one or more processors to:
evaluate each sentence of one or more sentences of the input document and storing the evaluations of the one or more sentences in a cache storage;
receive an indication the user modified an existing sentence or added a new sentence to the input document;
evaluate the modified sentence or the new sentence of the input document;
present the evaluation of the modified sentence or the new sentence in the editor; and
retrieve the evaluations of sentences that are unchanged from the cache storage without reevaluating the unchanged sentences.

12. The non-transitory computer-readable storage medium of claim 8, wherein the computer program instructions when executed further causes the one or more processors to:
present a dropdown element including the one or more topics; and
responsive to receiving the selected topic, present the one or more keywords as selection chips on the user interface.

13. The non-transitory computer-readable storage medium of claim 8, wherein the computer program instructions when executed further causes the one or more processors to:
provide the prompt to the model serving system via an API call to an endpoint of the model serving system, wherein the API call follows one or a combination of a REST API communication protocol, a RPC protocol, or a gRPC protocol.

14. The non-transitory computer-readable storage medium of claim 8, wherein the computer program instructions when executed further causes the one or more processors to:
identify one or more pieces of personal identifiable information (PII) entities in the prompt;
identify one or more placeholder entities for the one or more PII entities;
generate a modified prompt by replacing the PII entities with respective placeholder entities; and
responsive to receiving the response, replace the placeholder entities with the respective PII entities in the response.

15. A computer system, comprising:
a processor for executing computer program instructions; and
a non-transitory computer-readable storage medium storing computer program instructions when executed causes one or more processors to:
display a user interface configured with an editor to allow a user to enter and edit an electronic document;
responsive to receiving an indication from a user to generate starting text, present one or more topics and one or more keywords related to the topics for selection;
generate a prompt to a machine-learned language model, the prompt specifying at least the selected topic, the selected keywords, and a request to generate a set of candidate starter texts incorporating the selected topic and the selected keywords of the user;
receive, from the machine-learned language model, a response generated by executing the machine-learned language model on the prompt;
for a candidate starter text, detect issues for mitigation in the candidate starting text to evaluate whether a degree of the detected issues in the candidate starting text is less than a predetermined threshold;
generate a pane element on the user interface to present the candidate starting texts and an evaluation of the candidate starter texts to the user; and
responsive to receiving a selection of a candidate starter text, insert the selected candidate starter text as an input document into the editor of the user interface.

16. The computer system of claim 15, wherein the computer program instructions when executed further causes the one or more processors to:
apply a set of features to the candidate starter text, wherein a feature corresponds to detection of a respective category of bias, and wherein applying the feature to the candidate starter text generates an impact score for the category of bias;
generate an evaluation score for the candidate starter text by combining impact scores across the set of features; and
determine whether the evaluation score is less than the predetermined threshold.

17. The computer system of claim 16, wherein the computer program instructions when executed further causes the one or more processors to:
identify one or more phrases in the candidate starter text that are detected to have text with one or more categories of bias; and
for each identified phrase, generate indications over the phrases on the user interface associated with the category of bias for the identified phrase.

18. The computer system of claim 15, wherein the computer program instructions when executed further causes the one or more processors to:
evaluate each sentence of one or more sentences of the input document and storing the evaluations of the one or more sentences in a cache storage;
receive an indication the user modified an existing sentence or added a new sentence to the input document;
evaluate the modified sentence or the new sentence of the input document;
present the evaluation of the modified sentence or the new sentence in the editor; and
retrieve the evaluations of sentences that are unchanged from the cache storage without reevaluating the unchanged sentences.

19. The computer system of claim 15, wherein the computer program instructions when executed further causes the one or more processors to:
present a dropdown element including the one or more topics; and
responsive to receiving the selected topic, present the one or more keywords as selection chips on the user interface.

20. The computer system of claim 15, wherein the computer program instructions when executed further causes the one or more processors to:
provide the prompt to the model serving system via an API call to an endpoint of the model serving system, wherein the API call follows one or a combination of a REST API communication protocol, a RPC protocol, or a gRPC protocol.
